(19) United States
(12) Patent Application Publication
(10) Pub. No.: US 2013/0293003 A1
(43) Pub. Date: Nov. 7, 2013

(54) PROPULSION SYSTEM

(71) Applicant: ABB Oy, Helsinki (FI)

(72) Inventors: Sami KANERVA, Vantaa (FI); Kimmo Kokkila, Helsinki (FI); Mikko Kajava, Helsinki (FI)

(73) Assignee: ABB Oy, Helsinki (FI)

(21) Appl. No.: 13/932,509

(22) Filed: Jul. 1, 2013

Related U.S. Application Data
(63) Continuation of application No. PCT/EP2012/050021, filed on Jan. 2, 2012.

(30) Foreign Application Priority Data
Dec. 31, 2010 (EP) 10197479.8

(51) Int. Cl. B60L 11/08

(52) U.S. Cl. CPC B60L 11/08
USPC 307/9.1

(57) ABSTRACT

An arrangement is disclosed for supplying electric power to a propulsion system of a marine vessel having a propeller motor, which is connected to an AC generator. The AC generator supplies electric energy to the propeller motor. The AC generator is rotated by a rotating power unit. A frequency converter is electrically connectable in parallel to the AC generator and the frequency converter supplies electric power from a second power unit.

### RELATED APPLICATIONS

This application claims priority as a continuation application under 35 U.S.C. §120 to PCT/EP2012/050021, which was filed as an International Application on Jan. 2, 2012 designating the U.S., and which claims priority to European Application 10197478.9 filed in Europe on Dec. 31, 2010. The entire contents of these applications are hereby incorporated by reference in their entireties.

### FIELD

The present disclosure relates to an arrangement for supplying electric power to a propulsion system of a marine vessel.

### BACKGROUND INFORMATION

The propulsion power of large ships or marine vessels can be generated by a rotating power unit, whose energy source can be oil, gas, or nuclear power. The rotating power unit may be a diesel engine, gas turbine or nuclear power reactor rotating turbine. The mechanical output shaft is either directly or via a gear coupled to the shaft of the propeller, or the rotating power unit drives a generator, which supplies electric power to the propeller motors of the ship. Furthermore, several different combinations of these two main manners to drive the propeller have been utilized.

The power and energy efficiency of the marine vessel warrant that the propulsion power be generated as economically as possible in different operation modes. The overall energy consumption should therefore be optimized. That is, the electric energy should be generated using the most economical power production system that is available on board and the electric energy should be utilized as efficiently as possible when supplying the electric energy to the devices and motors using the electric energy.

As is known in the art, the propulsion devices can consume a majority of the energy expended in the marine vessels. Further, the propulsive force or thrust can be generated using simultaneously different kinds of engines or motors. Therefore, these devices should cooperate so that when producing the desired propulsive power and steering, their combined energy consumption is as low as possible.

At the same time the total energy consumption and the generation of electricity should be as efficient as possible. It is desireable that the total energy of the vessel is generated effectively and the electric power is supplied for use by all of the electric power consuming devices effectively in different operating situations.

Publication WO 02/072418 discloses a contra rotating propeller (CRP) arrangement where one propeller is driven by a main engine and another propeller is driven by an electric motor. The shafts of the first and second propellers are coaxial and the shaft of the first propeller is arranged in the hollow shaft of the second propeller. The main engine drives the first propeller coupled to the shaft of the main engine, and a generator arranged with respect to the shaft of the main engine supplies electric power to a motor that drives the second propeller. In addition, there are other engines that rotate generators that supply power to the motor.

Publication DE 3207398 discloses a CRP arrangement wherein the main engine rotates on propeller that is arranged on the hull of the ship, and another propeller is arranged relative to a rudder unit. The other propeller is rotated by a motor that is supplied from a generator driven by the main engine. The motor is connected directly to the generator or via a frequency converter. Alternatively, the motor is supplied via a main switch board from another generator driven by another main engine.

### SUMMARY

An arrangement is disclosed for supplying electric power to a propulsion system of a marine vessel, comprising: an AC generator; a propeller motor, which is connected to the AC generator for receiving electric energy from the AC generator, the AC generator being configured for rotation by a rotating power unit; and a frequency converter configured for electrical parallel connection with the AC generator for supplying electric power from a second power unit.

### BRIEF DESCRIPTION OF THE DRAWINGS

Exemplary embodiments will be described in more detail in the following by referring to the appended figures, in which:

FIG. 1 shows an exemplary embodiment as disclosed herein;

FIG. 2 shows another exemplary embodiment disclosed herein;

FIG. 3 shows an exemplary operation mode of the exemplary FIG. 2 embodiment;

FIG. 4 shows a second exemplary operation mode of the FIG. 2 embodiment;

FIG. 5 shows a third exemplary operation mode of the FIG. 2 embodiment;

FIG. 6 shows a fourth exemplary operation mode of the FIG. 2 embodiment;

FIG. 7 shows a fifth exemplary operation mode of the FIG. 2 embodiment;

FIG. 8 shows a third exemplary embodiment disclosed herein; and

FIG. 9 shows a fourth exemplary embodiment.

### DETAILED DESCRIPTION

A new and cost-effective arrangement is disclosed to supply electric power in a ship or marine vessel.

An exemplary arrangement for supplying electric power to a propulsion system of a marine vessel can include a propeller motor, which is connected to an AC generator and the AC generator supplies electric energy to the propeller motor, whereby the AC generator is rotated by a rotating power unit. A frequency converter is connectable in parallel to the AC generator and that the frequency converter supplies electric power from a second power unit.

According an exemplary embodiment, the frequency converter is connected by a switch to an electrical power connection, which connects the AC generator to the propeller motor.

According to an exemplary aspect, the frequency converter is switchable to the electrical power connection when changing the power distribution between a main propeller driven by the rotating power unit and a secondary propeller driven by the propeller motor.

According to an exemplary aspect, the electrical power connection includes a line breaker, and the generator and the frequency converter are alternatively switchable to the propeller motor when maneuvering the vessel.

According to an exemplary aspect, the arrangement includes a plurality of second power units, which rotate a plurality of auxiliary AC generators, whereby a main switch board is supplied by the auxiliary AC generators.

According to an exemplary aspect, the rotating power unit rotates a first propeller and the propeller motor rotates a second propeller, and the first and the second propellers form a CRP-system.

According to an exemplary aspect, the frequency converter supplies electric power from the second power unit to other consumers of electric power in the marine vessel depending on the power demand of the propellers.

When using exemplary arrangements disclosed herein, there can be more freedom in a ship's general arrangement and hull design as compared, for example, to the mechanical propulsion. The electric power generators can be positioned in a more advantageous way and the hydrodynamic efficiency of the vessel can be thereby improved.

The energy can be generated by a most efficient way in different operation situations and when fulfilling varying power demands of the vessel. Thereby the electrical losses of the marine vessel also can be minimized as compared to known electrical propulsion systems.

Exemplary arrangements disclosed herein can enable a configuring of the power generating plants and the engines using a primary energy source in a sensible way in accordance with the energy demands and specifications of the vessel. This gives freedom to choose a most suitable of the plurality of multiple power plant configurations and thus enables energy-efficient ship operation.

The energy generating machines such as diesel engines, and the propulsive power generating motors such as electric motors or a main propeller driving diesel can be distributed the vessel and they can be connected and disconnected. Thereby the redundancy of the propulsive units or their subunits can be increased.

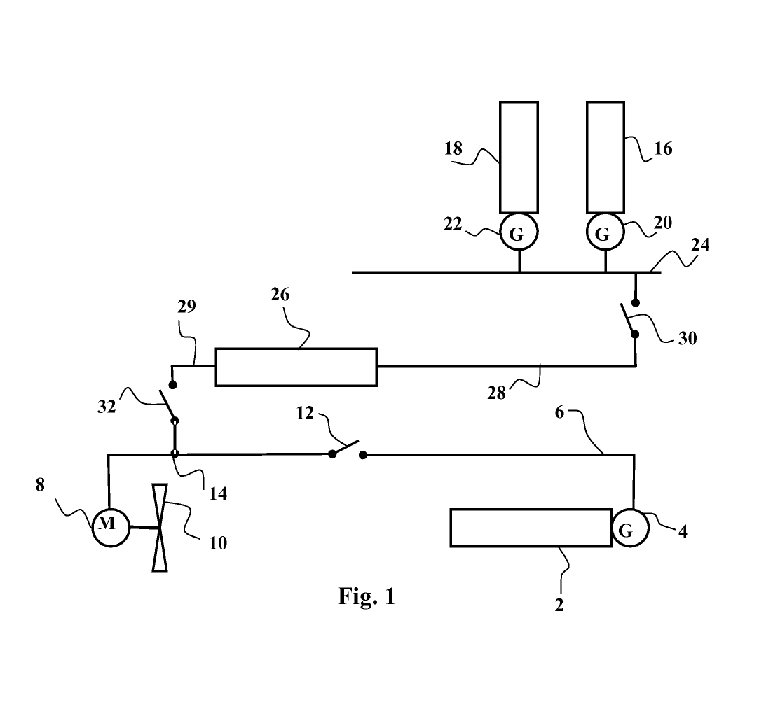

FIG. 1 shows a schematic diagram of a first exemplary embodiment wherein a rotating power unit 2 that is positioned inside the hull of the marine vessel rotates a generator 4. The rotating power unit 2 is, for example, a two-stroke diesel engine that uses oil as a fuel. The rotating power unit may also be another engine using some primary energy source like gas, nuclear power or fuel cells and so forth. The generator 4 is connected to the output shaft of the rotating power unit 2 either directly or via a gearbox. The rotational speed of the rotor of the generator 4 is thus the same as the rotational speed of the output shaft of the rotating power unit 2, or when having a gearbox, a ratio of their revolutions is defined by the transmission ratio of the gear.

The electrical output of the generator 4 is connected via an electrical power connection 6 to the propeller motor 8. The propeller motor 8 rotates the propeller 10 that is fixed onto the shaft of the motor. A circuit breaker 12 is installed in the electrical power connection 6 between the generator 4 and the junction point 14.

Two auxiliary rotating power units or second power units 16 and 18 are coupled to two generators 20 and 22, which are via electrical power connections connected to a main switchboard or a main bus 24 of the ship. The switchboard 24 is connected to the electric distribution mains of the vessel and the generators 20 and 22 supply the electric power to the consumers. The auxiliary rotating power units 16 and 18 are, for example, four-stroke diesel engines having lower power than the rotating power unit 2. The rotating power unit 2 and the auxiliary rotating power units 16 and 18 can be located in a suitable space in the hull of the vessel and they need not be positioned near the propeller 10 of the vessel or near the other consumers of the electric power. A frequency converter 26 is coupled between the main switchboard 24 and the junction 14 of the electrical power connection 6 via an electrical power connection 28 and via an electrical power connection 29 connecting, respectively. There is a second circuit breaker 30 between the main switchboard 24 and the frequency converter 26 and a third circuit breaker 32 between the frequency converter 26 and the junction 14.

The propulsive power is generated by the rotating power unit 2, by the auxiliary rotating power units 16 and 18 or by the rotating power unit 2 and by the auxiliary rotating power units 16 and 18 depending on the operation mode of the vessel. When the vessel is operating in normal mode and there is no need for any control actions the circuit breaker 12 is closed the propulsive power is delivered via the electrical power connection to the propulsion motor 8. The propulsion motor 8 is for example an AC motor, such as an asynchronous or a synchronous motor whose rotational speed is dependant on the frequency of the alternating current supplied by the ac generator 4.

The rotational speed of the generator 4 can be the same as the rotational speed of the rotating power unit 2, or if there is a gearbox in proportion of the transmission ratio. As both the generator 4 and the propulsion motor 8 are AC machines their rotational speed is proportional to the frequency of the alternating current and to the pole numbers of the machines. Thus, in case of synchronous machines their rotational speeds are the same when the pole numbers are the same, and inversely proportional to their pole numbers when they have different pole numbers. If the motor 8 is an asynchronous motor there is an additional difference because of the slip of the asynchronous motor. In the constant load situation the rotational speed of the propeller 10 is determined by the rotational speed of the rotating power unit 2. When additional propulsion power is desired, the second and the third circuit breakers 30 and 32 are switched on and the frequency converter 26 supplies an extra electric power to the propulsion motor 8 in parallel with generator 4.

When the vessel is operating in another mode, like starting or moving the vessel while prime mower is not in motion or the some of the rotating power units are not functioning properly, the arrangement in FIG. 1 can be controlled respectively to fulfill the control requirements. There may be a situation where auxiliary rotating power units 16 or 18 are not able to generate the required power for the devices connected to the switchboard 24 and the rotating power unit 2 has energy capacity more than propulsion motor requires. In that case all the circuit breakers 12, 30 and 32 and switched on and the frequency converter 26 is controlled to supply electric power towards the switchboard 24.

In some cases the rotating power unit 2 may be unavailable because of fault or because of other reason. Under such circumstances, the circuit breaker 12 is switched off and the electric power is supplied from the generators 20 and 22 via the electrical power connections 28 and 29 and controlled by the frequency converter 26.

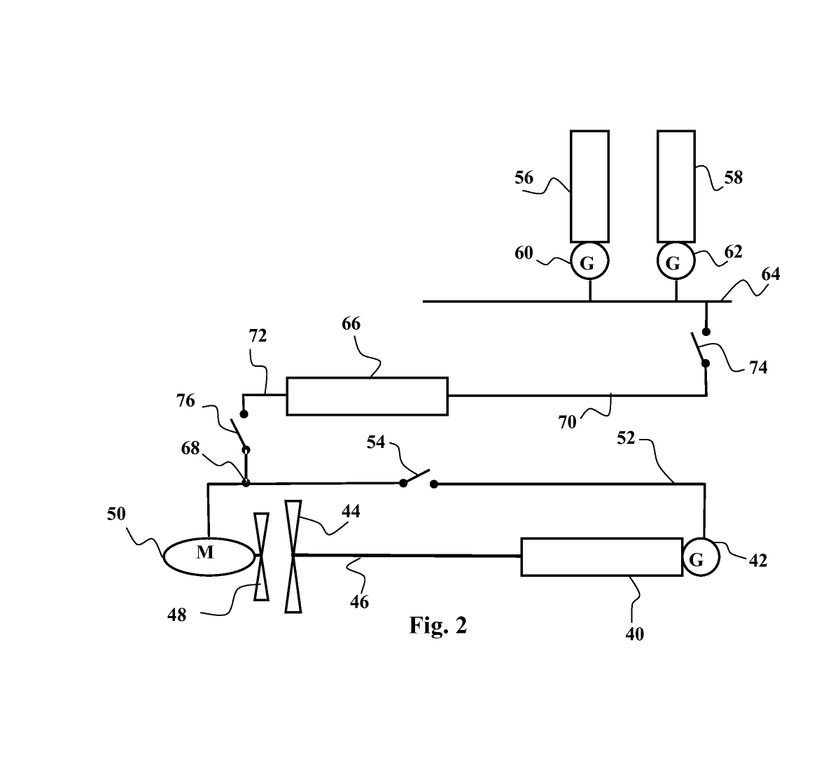

FIG. 2 shows a schematic diagram of another exemplary embodiment wherein a main rotating power unit 40 that is for example a two-stroke diesel engine drives a propulsion AC generator 42, whose rotor is fastened to the one output shaft of the rotating power unit 40. A main propeller 44 of the vessel is fastened onto another output shaft 46 of the rotating power unit 40. Though the generator 42 and the propeller 44 are on the opposite sides of the rotating power unit 40 in the embodiment shown in the FIG. 2, the generator may as well be on the same side of the rotating power unit 40 as the propeller 44.

Opposite to the main propeller 44 is arranged a second propeller 48 which is driven by an AC motor 50. The main or the forward propeller 44 is fitted with a bearing to the hull of the vessel. The second or the aft propeller 48 can be supported with the AC motor 50 by the hull of the vessel or by the rudder arrangement of the vessel. The forward propeller 44 and the aft propeller 48 are arranged to operate in a contra rotating propulsion (CRP) mode that is known in the art.

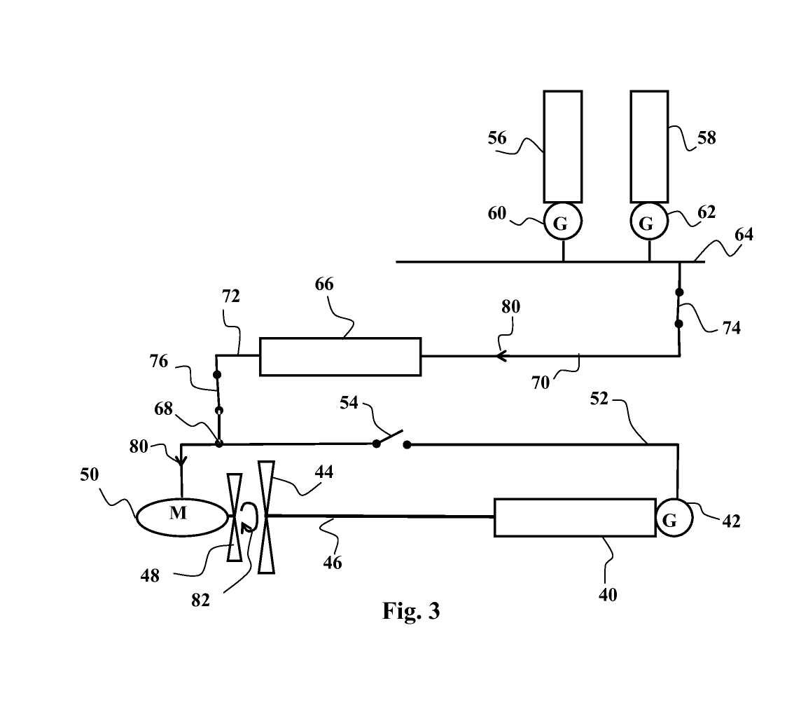

The propulsion AC generator 42 is connected to the AC motor 50 by an electrical power connection 52. A circuit breaker 54 is arranged on the electrical power connection 52 by which the connection between the AC motor 50 and the propulsion AC generator 42 can be switched on and switched off. When the circuit breaker 54 is switched on, the AC motor 50 and the propulsion AC generator 42 have the same frequency. Their rotational speed as well as the rotational speed of the aft and the forward propellers is effected by the frequency and their pole numbers as will be later clarified in detail in connection of different operating modes shown in FIGS. 3 to 8.

Two auxiliary rotating power units or second power units 56 and 58 are coupled to two generators 60 and 62, which are via electrical power connections connected to a main switchboard or a main bus 64 of the ship. The switchboard 64 is connected to the electric distribution mains of the vessel and the generators 60 and 62 supply the electric power to the consumers. The auxiliary rotating power units 56 and 58 are, for example, four-stroke diesel engines having lower power than the rotating power unit 40. The auxiliary rotating power units 56 and 58 can be located in a suitable space in the hull of the vessel and they need not be positioned near the propellers 44 or 48 of the vessel or near the other consumers of the electric power.

A frequency converter 66 is coupled between the main switchboard 64 and the junction 68 of the electrical power connection 52 via an electrical power connection 70 and via an electrical power connection 72 connecting, respectively. There is a second circuit breaker 74 between the main switchboard 64 and the frequency converter 66 and a third circuit breaker 76 between the frequency converter 66 and the junction 68.

The propulsion system shown in FIG. 2 can be operated and controlled in any of several ways depending on the operation mode. Referring to FIGS. 3 to 8, several operation modes will be clarified. When applicable the same reference numbers will be used the in FIGS. 3 to 8 as in the FIG. 2.

FIG. 3 shows the exemplary FIG. 2 embodiment in a maneuvering mode where the propulsion power is generated by the auxiliary rotating power units 56 and 58 where the main rotating power unit is not working. The propulsion power is generated by the aft propeller 48 as illustrated by the arrow 82 and forward propeller is at a standstill.

Thus the AC generator 42 neither is generating electric power and the circuit breaker 54 is switched off. The circuit breakers 74 and 76 are switched on and the electric power is supplied to AC motor 50 via the frequency converter 66 and via the main switchboard from the generators 60 and 62. The flow of the electric power is illustrated by the arrows 80. The power and frequency supplying the electric energy to the AC motor 50 is controlled by the frequency converter 66. The propulsion power of the aft propeller is limited to the capacity of the ac generators 60 and 62, and in practice to the capacity of the frequency converter 66.

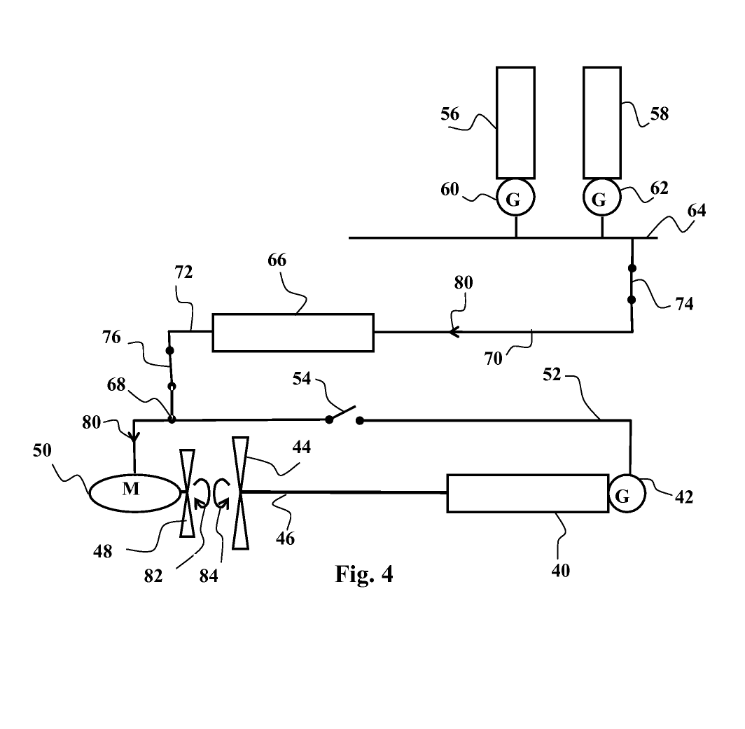

FIG. 4 shows the FIG. 2 embodiment in a first start-up mode where the propulsion power is generated by the auxiliary rotating power units 56 and 58 and the main rotating power unit 40. The aft propeller 48 and the forward propeller 44 function in the CRP-mode as is illustrated by the arrows 82 and 84. Though the main rotating power unit is functioning, the ac generator 42 is not generating electric power and the power circuit breaker 54 is switched off. The circuit breakers 74 and 76 are switched on and the electric power is supplied to AC motor 50 via the frequency converter 66 and via the main switchboard from the generators 60 and 62. The flow of the electric power is illustrated by the arrows 80.

The power and frequency supplying the electric energy to the AC motor 50 is controlled by the frequency converter 66. In this mode the speed of the aft propeller 48 can be controlled independently from the speed of the forward propeller 44. The main rotating power unit is working on a lowered power level, such as for example 25% of its nominal power and propulsion power of the forward propeller is for example about 25% of its total power (e.g., plus/minus 10 percent). The propulsion power of the aft propeller is limited to the capacity of the AC generators 60 and 62, and in practice to the capacity of the frequency converter 66.

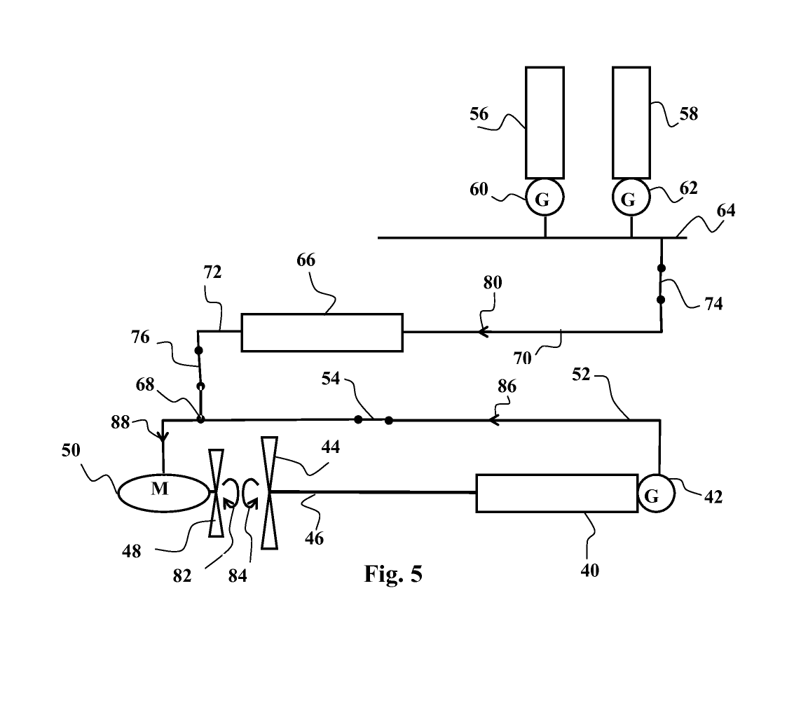

FIG. 5 shows the FIG. 2 embodiment in a second start-up mode where the propulsion power is generated by the auxiliary rotating power units 56 and 58 and the main rotating power unit 40. The AC motor 50 is supplied both from the AC generators 60 and 62 via the frequency converter 66 and from the AC generator 42 via the electrical power connection 52. The aft propeller 48 and the forward propeller 44 function in the CRP-mode as is illustrated by the arrows 82 and 84.

The main rotating power unit is functioning and the AC generator 42 is generating electric power and the power circuit breaker 54 is switched on. The circuit breakers 74 and 76 are switched on and the electric power is supplied to ac motor 50 via the frequency converter 66 and via the main switchboard from the generators 60 and 62. The flow of electric power from the AC generators 60 and 62 is illustrated by the arrow 80, the flow of electric power from the AC generator 42 is illustrated by the arrow 86 and the flow of electric power to the AC motor 50 is illustrated by the arrow 88.

The power and frequency supplying the electric energy to the AC motor 50 is controlled by the frequency converter 66. In this mode the power supply to the AC motor 50 is gradually moving from the AC generators 60 and 62 to the AC generator 42 by adjusting the output power of the ac generator 42 and controlling the frequency converter correspondingly. The main rotating power unit is working on a lowered power level, such as 25% of its nominal power and propulsion power of the forward propeller is again about 25% of its total power in order to keep the propulsion power levels of the aft and the forward propellers in the allowed limits.

The propulsion power of the aft propeller is limited to the capacity of the AC generators 60 and 62, and in practice to the capacity of the frequency converter 66 and a proper CRP function involves the propulsion powers of the aft and forward propellers being in the right proportion, for example between 50 to 50 and 20 to 80.

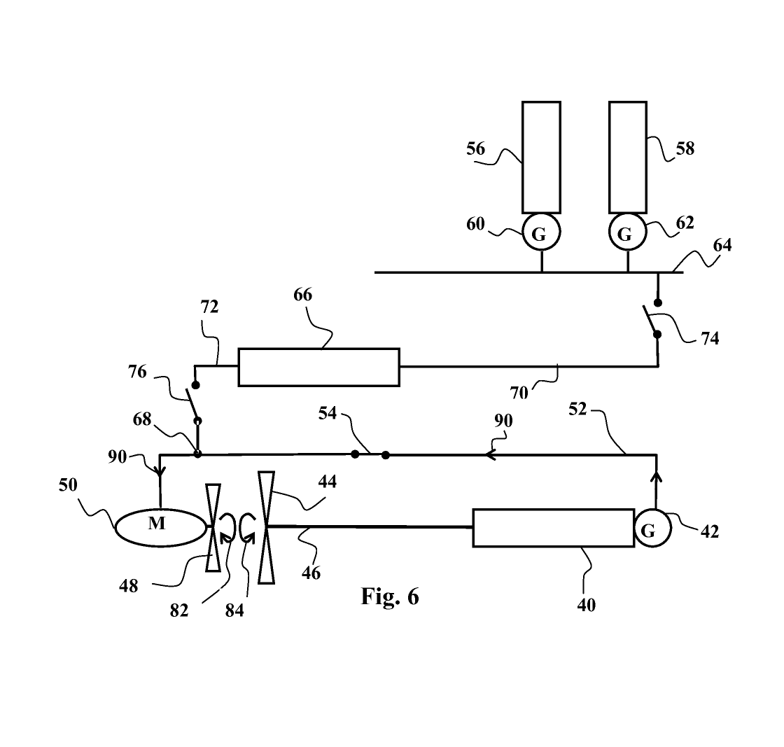

FIG. 6 shows the FIG. 2 embodiment in a third start-up mode where the propulsion power is generated by the main rotating power unit 40. This also illustrates a full speed and full power propulsion where the both propellers are functioning by the power of the main rotating power unit 40 and the AC generator 42 is directly connected to the AC motor 50. The circuit breaker 54 is switched on, whereas the circuit breakers 74 and 76 are switched off, and AC motor 50 is totally supplied from the AC generator 42 via the electrical power connection 52.

The aft propeller 48 and the forward propeller 44 function in the CRP-mode as is illustrated by the arrows 82 and 84. The flow of electric power to the AC motor 50 is illustrated by the arrows 90. During the third start-up mode the power of the main rotating power unit is increased from a lowered level, such as 25% towards its nominal power. In order to have an efficient CRP-function the propulsion powers of the aft and forward propellers are in the right proportion, for example between 50 to 50 and 20 to 80.

As the AC generator 42 is directly connected to the AC motor 50 via the electrical power connection 52, the AC generator 42 and the AC motor have the same frequency. When they both are synchronous machines, their rotational speeds differ from each other on the basis of the pole numbers of the machines. Correspondingly, the rotational speeds of the aft and forward propellers differ in the same way as they are fastened to the shafts of the machines.

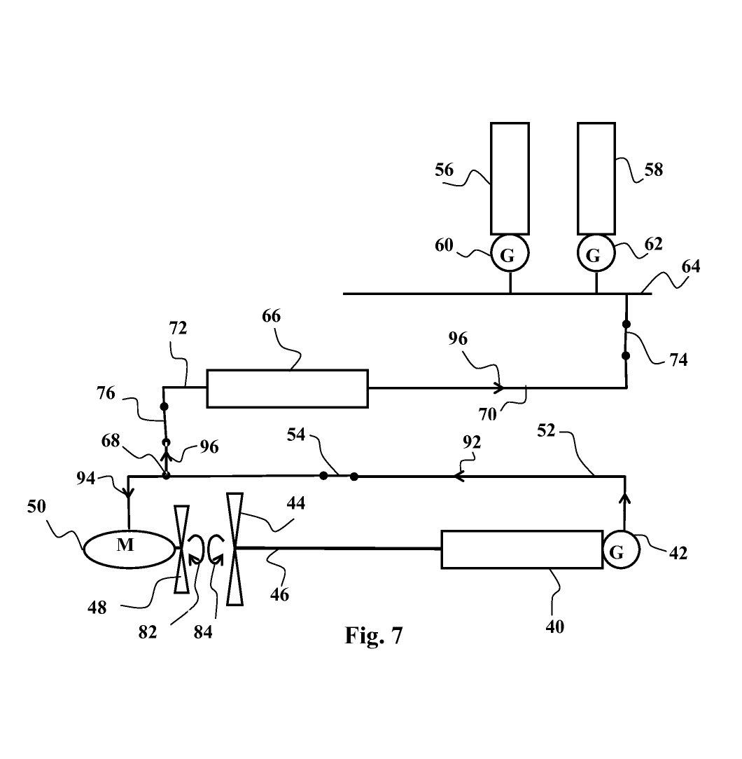

FIG. 7 shows the FIG. 2 embodiment in a fourth mode where the propulsion power is generated by the main rotating power unit 40. The main rotating power unit 40 is functioning at full power and the AC generator 42 is directly connected to the AC motor 50. The circuit breaker 54 is switched on and also the circuit breakers 74 and 76 are switched on and the frequency converter 66 is connected between the main switchboard 64 and the junction 68 of the line 52.

The AC motor 50 is totally supplied from the AC generator 42 via the electrical power connection 52. In addition the AC generator 42 is also supplying power to the main switchboard 64 as controlled by the frequency converter 66.

The flow of electric power to the AC motor 50 is illustrated by the arrow 94, the flow of electric power from the AC generator 42 is illustrated by the arrow 94 and flow of electric power to the main switchboard 64 is illustrated by the arrows 96. The propulsion power is lowered by the amount that is supplied to the main switchboard 64. In other respects the CRP functions as explained in connection of the FIG. 6.

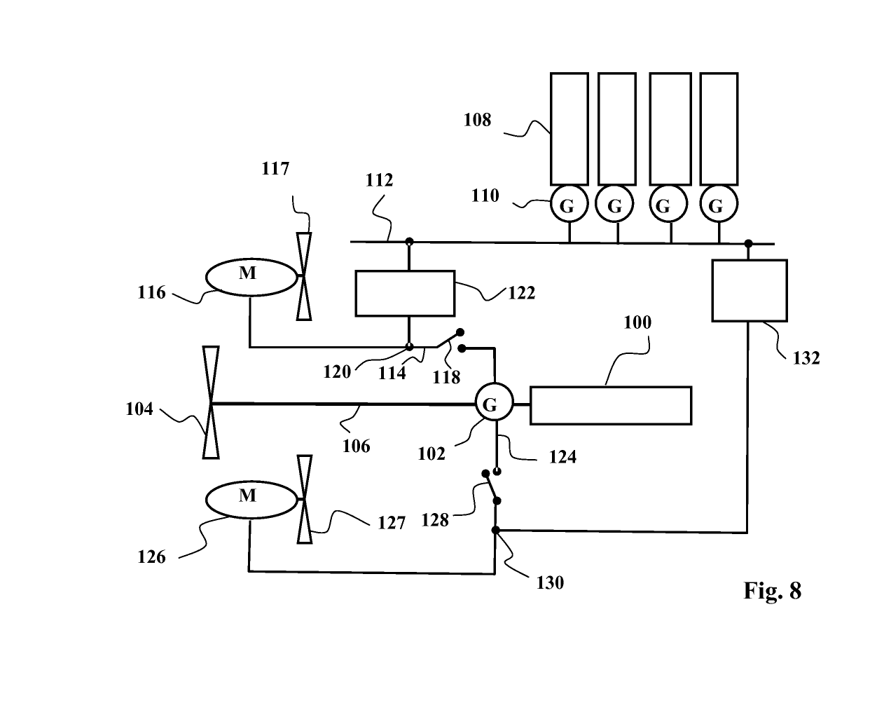

FIG. 8 shows a schematic diagram of another exemplary embodiment which includes one mechanical propeller and two electrical propellers. A main rotating power unit 100 that is for example a two-stroke diesel engine drives a propulsion AC generator 102, whose rotor is fastened to the output shaft of the rotating power unit 100. A main propeller 104 of the vessel is fastened onto the output shaft 106 of the rotating power unit 100.

Auxiliary rotating power units or second power units 108 are coupled to AC generators 110, which are via electrical power connections connected to a main switchboard or a main bus 112 of the ship. The main switchboard 112 is connected to the electric distribution mains of the vessel and the AC generators 110 supply the electric power to the consumers. The auxiliary rotating power units 108 are for example four-stroke diesel engines having lower power than the rotating power unit 100. The auxiliary rotating power units 108 and AC generators can be located in a suitable space in the hull of the vessel.

The output of the AC generator 102 is connected via electrical power connection 114 to a first propulsion motor 116. A circuit breaker 118 is arranged into the line 114 between the AC generator 102 and a junction 120. A frequency converter 122 is installed between the main switchboard 112 and the junction 120.

Another output of the AC generator 102 is connected via electrical power connection 124 to a second propulsion motor 126. A circuit breaker 128 is arranged into the line 124 between the ac generator 102 and a junction 130. Another frequency converter 132 is installed between the main switchboard 112 and the junction 130.

The propeller 117 driven by the first electric motor 116 is supplied directly from the AC generator 102. Alternatively, the first electric motor 116 is supplied from the main switchboard 112 and controlled by the frequency converter 122, or the first electric motor 116 is supplied from the main switchboard 112 and controlled by the frequency converter 122 and from the AC generator 102.

When the power is supplied from the AC generator, the rotational speed of the first motor is the same as the AC generator, or in case of different pole numbers proportional to it. Respectively, propeller speeds of the main propeller 104 and the propeller 117 are proportional to each other. The second motor 126 and the propeller 127 driven by it can be driven in the same way by the AC generator 102 and/or controlled by the frequency converter 132.

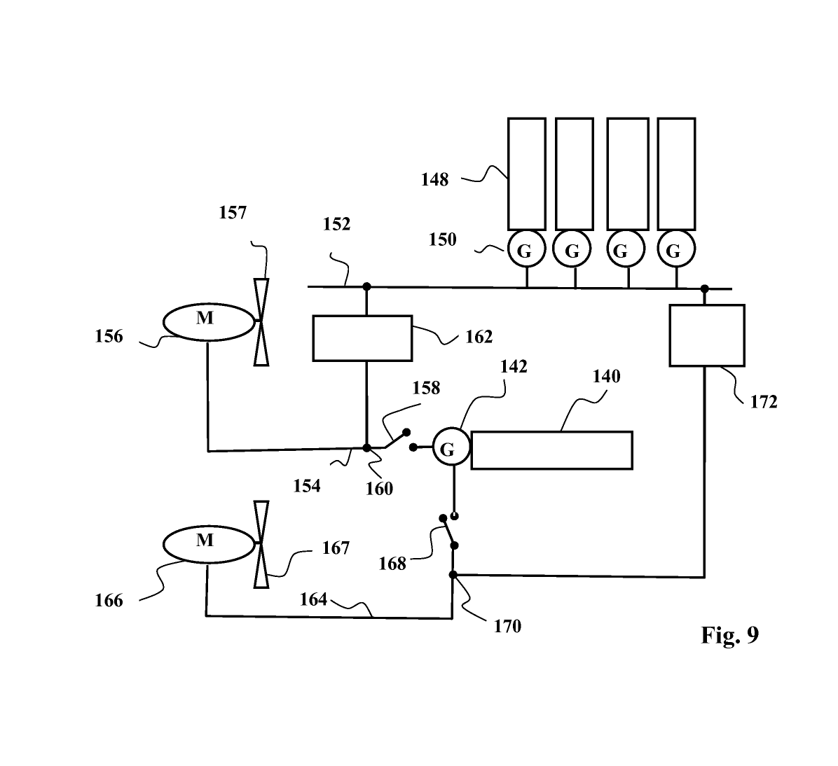

FIG. 9 shows a schematic diagram of another exemplary embodiment with two electrical propellers, a so called twin propeller. A main rotating power unit 140 that is for example a two-stroke diesel engine drives a propulsion AC generator 142, whose rotor is fastened to the output shaft of the rotating power unit 140.

Auxiliary rotating power units or second power units 148 are coupled to AC generators 150, which are via electrical power connections connected to a main switchboard or a main bus 152 of the ship. The main switchboard 152 is connected to the electric distribution mains of the vessel and the AC generators 150 supply the electric power to the consumers. The auxiliary rotating power units 148 are for example four-stroke diesel engines having lower power than the rotating power unit 140. The auxiliary rotating power units 148 and AC generators 150 can be located in a suitable space in the hull of the vessel.

The output of the AC generator 142 is connected via electrical power connection 154 to a first propulsion motor 156. A circuit breaker 158 is arranged into the line 154 between the AC generator 142 and a junction 160.

A frequency converter 162 is installed between the main switchboard 152 and the junction 160. Another output of the AC generator 142 is connected via electrical power connection 164 to a second propulsion motor 166. A circuit breaker 168 is arranged into the line 164 between the AC generator 142 and a junction 170. Another frequency converter 172 is installed between the main switchboard 152 and the junction 170.

The propeller 157 driven by the first electric motor 156 is supplied directly from the AC generator 142. Alternatively, the first electric motor 156 is supplied from the main switchboard 152 and controlled by the frequency converter 162, or the first electric motor 156 is supplied from the main switchboard 152 and controlled by the frequency converter 162 and from the AC generator 142.

When the power is supplied from the AC generator, the rotational speed of the first motor is the same as the AC generator, or in case of different pole numbers proportional to it. The second motor 166 and the propeller 167 driven by it can be driven in the same way by the AC generator 142 and/or controlled by the frequency converter 172.

The propulsion power of marine vessels according to exemplary embodiments disclosed herein can be generated by a rotating power unit, whose energy source is for example oil, gas, or nuclear power. The rotating power unit may be a diesel engine, gas turbine or nuclear power reactor rotating turbine. Further, a waste heat recovery system may be used that utilizes the exhaust gases of main engines by turbochargers. Both a first propeller and a second propeller may have fixed pitch or controllable pitch.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. An arrangement for supplying electric power to a propulsion system of a marine vessel, comprising:
an AC generator;
a propeller motor, which is connected to the AC generator for receiving electric energy from the AC generator, the AC generator being configured for rotation by a rotating power unit; and
a frequency converter configured for electrical parallel connection with the AC generator for supplying electric power from a second power unit.

2. The arrangement according to claim 1, comprising:
a switch, wherein the frequency converter is connected by the switch to an electrical power connection which connects the AC generator to the propeller motor.

3. The arrangement according to claim 2, wherein the frequency converter is configured to switch to the electrical power connection when changing the power distribution between a main propeller to be driven by the rotating power unit and a secondary propeller to be driven by the propeller motor.

4. The arrangement according to claim 2, wherein the electrical power connection comprises:
a line breaker, and wherein the AC generator and the frequency converter are configured to be alternatively switched to the propeller motor for maneuvering a vessel when in operation.

5. The arrangement according to claim 1, comprising:
a plurality of second power units for rotating a plurality of auxiliary AC generators; and
a main switch board connected to be supplied by the auxiliary AC generators.

6. The arrangement according to claim 1, in combination with a first propeller and a second propeller, wherein the rotating power unit is configured for rotating the first propeller, and the propeller motor is configured for rotating the second propeller, and wherein the first and the second propellers form a CRP-system.

7. The arrangement according to claim 1, wherein the frequency converter is configured for supplying electric power from the rotating power unit to other consumers of electric power in a marine vessel depending on power demand of propellers.

8. The arrangement according to claim 3, comprising:
a plurality of second power units for rotating a plurality of auxiliary AC generators; and
a main switch board connected to be supplied by the auxiliary AC generators.

9. The arrangement according to claim 8, in combination with a first propeller and a second propeller, wherein the rotating power unit is configured for rotating the first propeller, and the propeller motor is configured for rotating the second propeller, and wherein the first and the second propellers form a CRP-system.

10. The arrangement according to claim 9, wherein the frequency converter is configured for supplying electric power from the rotating power unit to other consumers of electric power in a marine vessel depending on power demand of propellers.

11. The arrangement according to claim 4, comprising:
a plurality of second power units for rotating a plurality of auxiliary AC generators; and
a main switch board connected to be supplied by the auxiliary AC generators.

12. The arrangement according to claim 11, in combination with a first propeller and a second propeller, wherein the rotating power unit is configured for rotating the first propeller, and the propeller motor is configured for rotating the second propeller, and wherein the first and the second propellers form a CRP-system.

13. The arrangement according to claim 12, wherein the frequency converter is configured for supplying electric power from the rotating power unit to other consumers of electric power in a marine vessel depending on power demand of propellers.

14. The arrangement according to claim 1, in combination with a marine vessel having at least first and second propellers for being driven by the propulsion system.
